(19) United States
(12) Patent Application Publication
(10) Pub. No.: US 2002/0028492 A1
(43) Pub. Date: Mar. 7, 2002

(54) Process for the oxidation of hydrocarbons using microorganisms

(75) Inventors: Hiltrud Lenke, Esslingen (DE); Laura Linja, Jokioinen/Finnland (DE); Ute Sieglen, Stuttgart (DE); Adolf Kuehnle, Marl (DE); Mark Duda, Ludwigshafen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Creavis Gesellschaft Fuer Techn. Und Innov. MBH

(21) Appl. No.: 09/842,808

(22) Filed: Apr. 27, 2001

(30) Foreign Application Priority Data
Apr. 27, 2000 (DE) 10020706.5
Jul. 7, 2000 (DE) 10033098.3

(51) Int. Cl. C02F 3/34; C12S 9/00

(52) U.S. Cl. 435/155; 435/264; 210/610

(57) ABSTRACT

Process for the oxidation of hydrocarbons having 2 to 20 carbon atoms using microorganisms such as bacterial strains such as Rhodococcus ruber KB1, Rhodococcus ruber DSM 7511, Rhodococcus ruber SW 3 or Arthrobacter sp. 11075, their natural mutants or genetically modified mutants. The process can be used for producing oxidation products of hydrocarbons such as alcohols with improved selectivity, and for cleaning up water or soil samples contaminated with hydrocarbons.

### BACKGROUND OF THE INVENTION

1. Field of the Invention

The invention relates to a process for the oxidation of hydrocarbons using microorganisms which possess an alkane hydroxylase enzyme system.

2. Discussion of the Background

Alkanes are the most economical raw material source for the chemical industry. They occur in large amounts, for example in natural gas. Because of their chemical inertness, they have, however, to date generally not been used directly for producing chemicals. Virtually all processes are based instead on the use of the higher-priced olefins. C₄ alcohols which, after methanol, are used in many industrial countries as quantitatively the most important alcohols are generally prepared from olefins. For example, butanol is generally prepared by hydroformylating propene with subsequent hydrogenation of the resultant butanal.

Other less important process are also used, such as processes via aldol condensation of acetaldehyde with subsequent hydrogenation of crotonaldehyde, and the Reppe process, that is to say the nickel-catalyzed reaction of propene with CO and water. Preparation methods based on the fermentation of sugar and starch are no longer of any importance compared with the current petrochemical processes, since, in addition to butanol, acetone is also formed. However, while inexpensive alkanes are readily accessible in natural gas and petroleum cracking gases, the previous chemical processes can only use this inexpensive starting material in a few cases.

To avoid the disadvantages of the previous chemical processes, a biotechnological processes in which a hydroxylated compound is prepared directly from the corresponding alkane with the aid of microorganisms would be industrially useful and economic. However, biotechnological processes using microorganisms which exhibit selectivity in their production of particular hydrocarbon oxidation products or which have tolerance to such oxidation products are required industrially. Such biotechnological processes would, in addition, avoid the disadvantages of the previously described fermentation processes and the isolation the corresponding enzymes.

To prepare a chemical product of value, for example an alcohol, further reaction of that product must be prevented so that a high selectivity can be achieved with respect to the desired product. The alcohol formed in the microorganism by the oxidation of the alkane is more reactive than the starting substance and is therefore readily further oxidized. The thermodynamic end product is CO₂. Thus, while microorganisms having an alkane hydroxylase activity may be used to breakdown hydrocarbons which are an environmental hazard, they do not necessarily produce oxidation products such as alcohols with adequate selectivity.

However, the selectivity of oxidation of a hydrocarbon to give a defined alcohol is of great importance in an industrial use, since separation of, for example, primary and secondary alcohols is frequently uneconomic. The primary alcohols in particular, for example 1-butanol, are of especial industrial relevance. Therefore, to prepare a chemical product of value, for example an alcohol, it is desirable to prevent further chemical reactions so that a high selectivity can be achieved with respect to the desired product.

Enzymes which catalyze the direct incorporation of molecular oxygen into an organic compound are widespread in nature and are called oxygenases. A differentiation is made between monooxygenases and dioxygenases depending on whether one or two oxygen atoms are incorporated into the organic molecule. Such enzyme systems are used by various microorganisms for reacting or breaking down aromatic and aliphatic hydrocarbons. Alkanes are generally broken down via the monooxygenation of the alkane to give the alkanol having a corresponding terminal alcohol group, then further oxidation to the aldehyde and the carboxylic acid takes place. The resultant compounds are then transferred by β-oxidation by further microorganism metabolism (Britton et al., Microbiol. Ser. 1984, 13, 89-121, Watkinson et al., Biodegradation 1990, 1, 79-82). In some microorganisms the terminal oxidation is followed by what is termed w-oxidation. After formation of the carboxylic acid, a further methyl group is oxidized, forming a dicarboxylic acid which can then be further broken down. In addition to the end-terminal oxidation, sub-terminal oxidation of aliphatic hydrocarbons also occurs. In this case ketones are formed which are converted to the corresponding ester by subsequent Baeyer-Villiger oxidation. The ester is hydrolytically cleaved, forming an alcohol and an acid. After oxidation of the alcohol, the fatty acids formed are converted further in the normal cellular metabolism. Beyond the monooxygenation, the oxidation of aliphatic hydrocarbons by a dioxygenase is described, but this is suspected to be less widespread in the microbial degradation of these compounds. The hydroperoxide formed in the oxidation is reduced to the corresponding alcohol in a further enzymatic step and, after further oxidation to the carboxyl group, can be transferred by β-oxidation to further microorganism metabolism.

Whereas the simplest alkane, methane, is converted to methanol by a soluble monooxygenase, the monooxygenases of microorganisms which break down alkanes having a chain length ≧C₂ are generally localized in the cytoplasmic membrane. Although the methylotrophic microorganisms can only grow with C₁ compounds, their methane monooxygenase can nevertheless convert C₁-C₈ alkanes to the corresponding alcohol. The use of such a methylotrophic bacterium has been described for the hydroxylation of alkanes in EP 0088602. Here, first, a cell-free extract of the bacteria, which have previously been cultured aerobically on a C₁ compound (methane, methanol), is produced. This cell-free extract contains the monooxygenase which can be used to oxidize, for example, butane to butanol or to epoxidize ethene. The presence of a cofactor such as NADH₂ or NADPH₂ is absolutely necessary. Undesirably, the selectivities in the oxidation of, for example, n-butane to 1-butanol or 2-butanol are, at 1:0.5, too low for industrial applications.

EP 98138 describes bacteria which can oxidatively break down C₂-C₁₀ alkanes. These are various newly isolated strains of:

-Acinetobacter sp.

-Arthrobacter sp.

-Brevibacterium sp.

-Mycobacterium sp.

-Corynebacterium sp.

-Nocardia sp.

-Pseudomonas sp.

However, the selectivity of these bacteria in the oxidation of n-butane to 1-butanol or 2-butanol is approximately 1:0.5, and is therefore not sufficient for an industrial process.

The alkane hydroxylase of the alkane-degrading bacterium Pseudomonas oleovorans has been studied for almost three decades. Alkanes having a chain length of C₆-C₁₂ are the substrates of this hydroxylase. This reaction has also been used in recent years for preparing primary alcohols starting from the n-alkanes. The substrate was octane. For this purpose plasmids which contain the gene for the alkane hydroxylase are transferred into a closely related Pseudomonas strain which, as a result, was rendered capable only of alkane oxidation, but did not convert the resultant alcohol further (Bosetti et al., Enzyme Microb. Techn. 1992, 14, 702-708). Recently, the alkane hydroxylase has successfully been expressed in an Escherichia coli strain at 10- 15% of total protein (Nieboer et al., J. Bact. 1997, 179, 762-768).

While EP 0277674 describes a process for preparing compounds containing hydroxyl end groups or epoxy end groups using genetically manipulated microorganisms, the system is restricted to n-alkanes, n-alkenes and n-alkadienes having 6 to 12 carbon atoms and the oxidation is described without specifying the selectivity of n-octane. It is also a disadvantage that the initial activity of the oxygenases greatly decreases in the course of time.

The use of bacteria or fungi has been extensively studied, for example by McLee et al., in Can. J. Microbiol. 18 (1972) 1191-1195 or Ashraf et al., in FEMS Microbiol. Let. 122, 1994, 1-6. The microorganisms studied, however, did not have the selectivities or tolerances to the oxidation products which are required industrially.

Although the strain Pseudomonas butanovora (identical to Acidovorax sp. FEMS 2080) described by D. Arp in Microbiology (1999, 145, 1173 - 1180) converts butane to butanol, it converts it with an industrially insufficient selectivity to 1 -butanol. In addition, the use of propanol to prevent further oxidation of butanol is a disadvantage here.

Since various enzyme systems are used in microorganisms for the individual oxidation steps, it is possible to isolate the desired oxidation product by working with cell- free systems, that is to say with the pure enzyme required for the reaction. Alternatively, by genetic manipulation of the microorganisms so that they are no longer capable of converting the desired oxidation product to a significant extent, the breakdown of the substrate to unwanted products can be prevented.

In principle, various types of genetic manipulation are also possible. Thus, microorganisms such as Pseudomonas oleovorans contain a plurality of genes which code for alkanol dehydrogenase. Deactivation or removal of the alkanol dehydrogenase gene has the effect that the first oxidation product, the respective alcohol, cannot be converted further. Thus, in the conversion of the alkane, an accumulation of the corresponding alkanol is achieved.

Furthermore it is possible to transfer alkane hydroxylases from an alkane-degrading microorganism to a suitable foreign organism. In this recombinant organism, only the first reaction step of the alkane degradation sequence should take place, which again leads to accumulation of the desired alkanol.

In addition to these possible ways of restricting further reaction of the oxidation product, the use of inhibitors which, for example, act selectively on the alkanol dehydrogenase, is also conceivable.

However, the insufficient regioselectivity of oxidation by microorganisms is a disadvantage in the previously known processes for the oxidation of alkanes, alkenes and/or alkadienes using microorganisms. Thus, for example, the terminal alcohols are generally much more important, from the economic aspect, than the corresponding secondary alcohols. In addition, the formation of the carbonyl compound, that is to say the secondary product of oxidation of the desired target substance, must be avoided as far as possible.

Another problem that the prior microbiological processes do not significantly address is to what extent the microorganisms used are resistant to the product formed, even though it is known that substances such as alcohols have a harmful action on many microorganisms even at low concentrations (EP 0277674). However, for an industrial use of such a biotechnological process, high tolerance of the organisms towards the target product is essential.

Thus, there is a need to develop an industrially useful and economic process using a microorganism which is tolerant to the primary oxidation products of hydrocarbons, and which improves the selectivity of the conversion of hydrocarbons, such as alkanes, to particular oxidation products.

### SUMMARY OF THE INVENTION

An object of the present invention is a process by which the oxidation of hydrocarbons to alcohols using microorganisms which possess an alkane hydroxylase enzyme system and which are tolerant towards the primary oxidation product, that is to say the alcohols thus produced, proceeds successfully on an industrially utilizable scale and in an industrially utilizable selectivity. It is desirable that the selectivity of such process be above 1: 1, preferably at least 2:1 or 3: 1, most preferably at least 4:1.

Another object of the present invention is a process which selectively produces particular oxidation products of hydrocarbons, such as hydrocarbons having 2 to 20 carbon atoms. Such process may comprise the use of particular microorganisms, such as bacterial strains Rhodococcus ruber KB1, Rhodococcus ruber DSM 7511, Rhodococcus ruber SW 3 or Arthrobacter sp. 11075, and mutants or variants thereof, such as their natural mutants or genetically modified mutants.

Besides the above aspects of the invention, other aspects, objects and embodiments of the present invention will be clear from the disclosure.

### DETAILED DESCRIPTION OF THE INVENTION

One embodiment of the present invention relates to a process for the oxidation of hydrocarbons having 2 to 20 carbon atoms using bacteria. Such hydrocarbons are oxidized using bacterial strains falling within the genera including Rhodococcus ruber KB1, Rhodococcus ruber DSM 7511, Rhodococcus ruber SW 3, and Arthrobacter sp. 11075, as well as mutants and variants of such strains. Such mutants and variants may be produced by conventional mutagenesis procedures, including the use of radiation, such as UV or X- radiation, and chemical mutagens, such as N-methyl-N' nitro-N-nitrosoguanidine, ethyl methane sulphonate, or nucleotide analogs, followed by screening for the desired functional activity, such as an ability to oxidize hydrocarbons having 2 to 20 carbon atoms, for their ability to selectively or efficiently produce certain products, or for their tolerance to particular oxidation products of hydrocarbons. Genes which confer the functional ability to oxidize hydrocarbons or alkanes can be transferred using conventional genetic or recombinant DNA techniques from microorganisms such as Rhodococcus ruber KB1, Rhodococcus ruber DSM 7511, Rhodococcus ruber SW 3, and Arthrobacter sp. 11075 to other host cells capable of expressing the desired activity. Such genes also encompass substantially similar genes which hybridize under stringent conditions (e.g. 0.1×SSC, 0.1% SDS, 65 degrees C.) with the corresponding genes from strains such as Rhodococcus ruber KB1, Rhodococcus ruber DSM 7511, Rhodococcus ruber SW 3, and Arthrobacter sp. 11075, and which confer the functional ability to oxidize hydrocarbons or alkanes, such as hydrocarbons having 2 to 20 carbon atoms. While conventional hybridization procedures and stringency conditions are well-known to those with skill in the art, they may also be determined by reference to Sambrook et al., Molecular Cloning: A Laboratory Manual, 3_{rd} edition (2001), Cold Spring Harbor Laboratory Press.

In another embodiment of the present invention, an alcohol corresponding to the oxidized hydrocarbon is obtained. Thus, for example, 1-butanol or 2-butanol can be produced from n-butane. Preferably, the oxidation of the hydrocarbons proceeds terminally, that is to say alcohols are obtained which are oxidized in the 1 position (for example 1-butanol). Particularly preferably, the terminal oxidation proceeds with a selectivity of more than about 80%, preferably 80-90%, particularly preferably more than 90%, that is to say the ratio of primary alcohols to secondary or tertiary alcohols should not fall below about 4:1.

For these bacterial strains, it can be shown by measuring the optical density, that alkanes can be utilized as sole carbon source and energy source in a liquid mineral medium. Furthermore, bacterial strains which have been enriched and isolated using n-butane in the gas phase as sole carbon source and energy source likewise exhibit good growth with hydrocarbons having 2-7 carbon atoms. All bacterial strains used according to the invention also exhibit good growth on solid mineral medium in a desiccator when n-hexane is added via the gas phase. Via culture on solid nutrient media, these alkane-degrading bacterial strains can be obtained in lyophilized form or at −70° C. Bacterial strains which have been enriched in the presence of 1-2 percent 1-butanol exhibit, in contrast to other strains which have not been enriched in this manner, good growth in a complex medium in the presence of 1.5-2.5% 1-butanol. They therefore possess the capability of tolerating the primary oxidation product of butane, 1-butanol. These bacterial strains can also be cultured on solid complex media, in lyophilized form or at −70° C.

In the inventive process for the oxidation of hydrocarbons, the microorganisms can be used in the form of whole cells in suspension or cells in immobilized form, in the form of cell-free extracts which either contain the soluble enzyme fraction or the membrane-bound enzyme fraction or both. This also means that the enzymes, that is to say the hydroxylases, can be used in immobilized form on a stationary phase. The cell of the microorganism or its cell-free extract can be immobilized on, or bound to, for example, an insoluble matrix, by covalent, chemical bonds or absorption. The matrix which can be used is, for example, a gel having a pore structure in which the enzymes or the hydroxylase are/is immobilized. For the industrial conversion, the use of a membrane as stationary phase is also possible.

Cell-free extracts or the isolated hydroxylase can also be produced from the recombinant bacterial strains.

Substrates which may be used in the inventive process are aliphatic compounds and/or aromatic compounds having an aliphatic side chain. When aromatics are used, it is preferably an aliphatic substituent which is oxidized. Preferably, branched or unbranched alkanes having 2 to 20, particularly preferably 2 to 7, carbon atoms are used as substrate. Examples which may be mentioned are ethane, propane, butane, butane mixtures such as C₄ fractions, or natural gas, pentane, hexane, heptane, octane. Functional groups on the alkyl radical do not interfere with the conversion, provided that they are tolerated by the microorganism.

It is also possible to use hydrocarbon mixtures, including mixtures of different hydrocarbon isomers. Here, preferably, and essentially only, the unbranched hydrocarbons are oxidized.

It is known that microorganisms which can utilize alkanes as carbon source can also convert alkenes and alkadienes. The olefins are primarily oxidized to the 1,2-epoxides.

In other embodiments of the present invention, further oxidation or reaction of the primary product (alcohol) is impeded or suppressed. It is thus possible to employ cell-free systems, that is to say only the pure enzyme required for the reaction. The enzymes present in the microorganism for further oxidation of the alcohol are not then available. In addition, there is the possibility of genetic manipulation of the microorganisms such that they are no longer able to convert the desired oxidation product further to a significant extent. In principle, for example, various types of genetic manipulation are possible. Thus, in microorganisms that contain genes which code for the alkanol dehydrogenases, selective deactivation or removal of one or more alkanol dehydrogenase genes can produce a strain in which the first oxidation product, that is to say the respective alcohol, can no longer be converted further, and thus an accumulation of the corresponding alkanol is achieved.

Furthermore, it is possible to express the genes of the bacterial strains directly required for hydrocarbon oxidation from the alkane-degrading microorganism heterologously in another suitable bacterial strain, that is to say a foreign organism, that is to say to use bacterial strain as foreign organism to the bacterial strains according to the main claim. In a recombinant organism thus produced, only the first reaction step of the alkane degradation sequence still takes place.

As a recombinant organism, it is suitable to express the genes which code for the hydrolase in, for example, Escherichia coli. This is described by way of example in Bosetti et al., Enzyme Microb. Techn. 1992, 14, 702-708. In addition, alcohol-tolerant bacterial strains, for example Corynebacterium sp. US-K1, Corynebacterium sp. US-K5, Bacillus sp. US-K4 or Bacillus subtilis US-K2, can be used as recombinant foreign organism for heterologous expression of such genes.

For this, customary genetic engineering methods can be used (Sambrook, J., E. F. Fritsch, and T. M. Maniatis, 1989, Molecular Cloning: A Laboratory Manual, 2nd ed., Cold Spring Harbor Laboratory Press, USA), as can the method of differential display (Welsh J., K. Chada, S. S. Delal, R. Cheng, D. Ralph and M. McClelland, 1992, Arbitrarily primed PCR fingerprinting of RNA, Nucleic Acid Res. 20:3965-4970. Wong. K. K. and M. McClelland, 1994, Stress-inducible gene of Salmonella typhimurium identified by arbitrarily primed PCR of RNA. Proc. Natl. Acad. Sci. USA, 91: 639-643).

In addition to these biological methods of restricting the further reaction of the oxidation product, inhibitors which act selectively on the alkanol dehydrogenase used in the inventive process can also be employed. The alcohols are then obtained by oxidation of the hydrocarbons in the presence of an inhibitor.

Inhibitors of this type are compounds which are conventionally used for this purpose, for example, pyrazole derivatives, 1,10-phenanthroline, paramercuribenzoate, imidazole derivatives, cyanide compounds, hydroxylamides or α,α-bipyridyl.

The inventive process can be carried out at a temperature of ranging from about 0 to 100°C., preferably at a temperature of 10 to 60° C., and particularly preferably at a temperature of 20 to 40° C. It is preferably carried out at a pH of 4 to 9, particularly preferably at a pH of 5.5 to 8.0. The inventive process can be carried out either at atmospheric pressure or at elevated pressure up to 10 bar. If gaseous hydrocarbons are employed, any ratio between the proportions of hydrocarbon, oxygen and inert gas can be used, operation outside the respective explosive limits being preferred. The oxidizing agent can be either atmospheric oxygen or pure oxygen.

The inventive process can be carried out not only batchwise, in the fed-batch procedure, but also continuously, the substrate to be oxidized being able to be fed to the reaction mixture either in the gaseous or liquid state. In addition, a two-phase system can be used having an organic phase which consists of the substrate and/or has the object of extracting the oxidation product.

Membrane reactors are also suitable for the process of the invention. The membrane here can firstly have the object of retaining the microorganisms or enzymes in the reaction solution and/or selectively removing the oxidation product from the reaction solution.

The reaction can proceed either with single, repeated or continuous substrate addition. The gaseous reactants can be added by diffusion from the gas phase above into the reaction medium or else by introducing the gases into the reaction medium. Obviously, dosage through a semipermeable wall, for example, is also possible.

The inventive process may also be used for the breakdown of hydrocarbons in soil and water, that is for their decontamination, purification or cleanup. Such a process involves mixing or adding a microorganism, such as a bacteria expressing alkane hydroxylase activity or a strain such as Rhodococcus ruber KB1, Rhodococcus ruber DSM 7511, Rhodococcus ruber SW 3 or Arthrobacter sp. 11075, which breaks down hydrocarbons within the contaminated substrate, such as soil, solid waste, sludge, sewage or liquid waste that contains the hydrocarbons to be removed, in an amount and under conditions suitable for breakdown of hydrocarbons. Such processes may also employ other compounds, such as other carbon or energy sources, minerals or nutrients which facilitate the growth or metabolism of the microorganisms breaking down the hydrocarbons.

The following examples are intended to describe the invention in more detail without restricting its protective scope as defined in the patent claims.

The newly isolated bacterial strains were deposited at the DSMZ (Deutsche Sammlung von Mikroorganismen and Zellculturen GmbH, Brunswick) in accordance with the Budapest Treaty under the following deposition numbers in Table I below:

TABLE I

| Bacterial strain | Deposition number |
|---|---|
| Bacillus subtilis US-K2 | DSM 13402 |
| Corynebacterium sp. US-K1 | DSM 13401 |
| Bacillus sp. US-K4 | DSM 13403 |
| Corynebacterium sp. US-K5 | DSM 13404 |
| Rhodococcus ruber KB1 | DSM 13405 |
| Rhodococcus ruber SW3 | DSM 13406 |

Examples:

1. Oxidation experiments (studies on the selectivity of butane oxidation and hexane oxidation)

1.1 Enrichment and isolation of alkane-degrading bacterial strains

The newly isolated alkane-degrading bacterial strains were enriched and isolated as follows. Mineral medium (50 ml) of the following composition:

| | | | |
|---|---|---|---|
| Na₂HPO₄ • 2H₂O | | 7.0 | g |
| KH₂PO₄ | | 1.4 | g |
| Ca(NO₃)₂ • H₂O | | 0.005 | g |
| MgSO₄ • 7H₂O | | 0.02 | g |
| (NH₄)₂SO₄ | | 0.1 | g |
| Fe(III)NH₄ citrate | | 0.001 | g |
| ZnSO₄—7H₂O | | 0.1 | mg |
| MnCl₂—4H₂O | | 0.03 | mg |
| H₃BO₃ | | 0.3 | mg |
| CoCl₂ • H₂O | | 0.2 | mg |
| CuCl₂ • 2H₂O | | 0.01 | mg |
| NiCl₂ • 6H₂O | | 0.02 | mg |
| NaMoO₄ • 2H₂O | | 0.02 | mg |
| H₂O_{twice-distilled} | to | 1,000 | ml |

was admixed with approximately 5 g of soil or 1-2 ml of activated sludge from a sewage treatment plant and incubated with 7-14% n-butane in the gas phase as sole carbon and energy source at 30° C. in a 500 ml conical flask equipped with baffles. If a marked decrease in n-butane concentration was observed, an aliquot was plated out on solid complex nutrient 10 media. The bacterial strains enriched in this manner were isolated as individual strains and using these the growth using n-butane as carbon source and energy source was tested. This produced pure cultures of bacterial strains which were able to grow using n-butane.

1.2 Culturing the bacterial strains using n-butane as an example of a gaseous alkane

For the growth of bacterial strains in liquid cultures using n-butane as sole carbon and energy source, the above-described nutrient medium was used with 5-7% n-butane in the gas phase. The ratio of liquid phase to gas phase was generally 1:5 or 1:10. Air-tightly sealed conical flasks equipped with baffles were used for the culturing. The cell suspensions were generally incubated for 1-2 days at 30° C. on a rotary shaker at 120 rpm.

1.3 Culturing the bacterial strains using n-hexane as an example of a liquid alkane

For the growth of bacterial strains in liquid cultures using n-hexane as sole carbon and energy source, the above-described nutrient medium was used with addition of 0.1% n-hexane. Air-tightly sealed conical flasks equipped with baffles were used for culturing, in which the ratio of liquid phase to gas phase was also 1:5 or 1:10. The cell suspensions were generally incubated for 1-2 days at 30° C. on a rotary shaker at 120 rpm.

1.4 Identification of the bacterial strains

Newly isolated bacterial strains were classified by partial 16S rDNA sequencing. Sequencing was performed using Sanger's dideoxy chain method.

1.5 Long-term culturing

The alkane-degrading bacterial strains were maintained on solid mineral medium plates at 4° C. which had been previously incubated in a desiccator for 3-4 days at 30° C. The n-hexane was added via the gas phase as a carbon and energy source. The bacterial strains were transferred every 2 weeks onto fresh solid nutrient media. For solid nutrient media, 15 g of agar/1 were added to the above-described medium. In addition, all bacterial strains were stored at −70° C. For this, 0.5 ml of a preculture growing with n-butane was mixed with 0.5 ml of glycerol and shock-frozen in liquid nitrogen in a cryotube.

1.6 Activity measurements

1.6.1 Conversion of n-butane by microorganisms

In accordance with the above-described culture method, cells of bacterial strains which break down n-butane were grown in mineral medium together with 7% n-butane in the gas phase. At the end of the exponential growth phase, the cells were harvested by centrifugation and resuspended in phosphate buffer to give an optical density of 2-5. Each cell suspension was transferred to 300 ml conical flasks equipped with baffles, sealed air-tightly and, using a gas-tight syringe, 6% of air was replaced by corresponding amounts of n-butane. After determining the optical density, each cell suspension was incubated at 30° C. in a shaking water bath at 100 rpm. At intervals of initially half an hour, later one hour or longer, gas samples were taken using an air-tight syringe and analyzed by GC. In addition, samples were taken for determination of the 1-butanol and 2-butanol concentration. For this, 1 ml of the liquid phase was sampled using a sterile disposable syringe and centrifuged for 2 minutes in a bench centrifuge. The supernatant was then analyzed by GC for the contents of 1- and 2-butanol. In all of the conversions, a decrease in n-butane was observed, but, in contrast, since no inhibitor was used, the accumulation of 1- or 2-butanol was not observed.

The total oxidation product CO₂ was detected, see Table II, below.

TABLE II

| | | Activity in |
|---|---|---|
| | Strain | nmol/min/mgₚᵣₒₜₑᵢₙ |
| Not according to | Mycobacterium sp. 11435 | 13.2 |
| the invention | | |
| According to | Rhodococcus ruber KB1 | 49.0 |
| the invention | | |
| According to | Arthrobacter sp. 11075 | 34.4 |
| the invention | | |
| According to | Rhodococcus ruber DSM 7511 | 31.4 |
| the invention | | |
| According to | Rhodococcus ruber SW3 | 35.9 |
| the invention | | |

1.6.2 Conversion of n-hexane by microorganisms

In accordance with the above-described culture method, cells of bacterial strains which break down n-hexane were grown in mineral medium containing 0.1% n-hexane. At the end of the exponential growth phase, the cells were harvested by centrifugation and resuspended in phosphate buffer to give an optical density of 2-5. Each cell suspension was transferred to 300 ml conical flasks equipped with baffles. After determining the optical density, and after adding 0.1% of n-hexane, the solution was sealed air-tightly and each cell suspension was incubated at 30° C. in a shaking water bath at 100 rpm. At intervals of initially half an hour, later one hour or longer, gas samples were taken using an air-tight syringe and analyzed by GC. In addition, samples were taken for determination of the 1-, 2- and 3-hexanol concentration. For this, 1 ml of the liquid phase was sampled using a sterile disposable syringe and centrifuged for 2 minutes in a bench centrifuge. The supernatant was then analyzed by GC for the contents of 1-, 2- and 3-hexanol. In all of the conversions, a decrease in n-hexane was observed, but, in contrast, since no inhibitor was used, the accumulation of 1-, 2- and 3-hexanol was not observed. The total oxidation product CO₂ was detected, see Table III below:

TABLE III

| | | Activity in |
|---|---|---|
| | | nmol/min/ |
| | Strain | mgₚᵣₒₜₑᵢₙ |
| Not according to the invention | Mycobacterium | 4.5 |
| | sp. 11435 | |
| According to the invention | Rhodococcus ruber KB1 | 21.6 |
| According to the invention | Arthrobacter sp. 11075 | 11.0 |

1.6.3 Conversion of n-butane using microorganisms and 4-methylpyrazole as inhibitor

In accordance with the above-described culture method, cells of bacterial strains which break down n-butane were grown in mineral medium together with 7% n-butane in the gas phase. At the end of the exponential growth phase, the cells were harvested by centrifugation and resuspended in phosphate buffer to give an optical density of 2-5. Each cell suspension was transferred to 300 ml conical flasks equipped with baffles. After addition of 4-methylpyrazole as inhibitor, the flasks were sealed air-tightly and 6% of air was replaced by the corresponding amounts of n-butane using a gas-tight syringe. Each cell suspension was then incubated at 30° C. in a shaking water bath at 100 rpm. At intervals of initially half an hour, later one hour or longer, gas samples were taken using an air-tight syringe and analyzed by GC. In addition, samples were taken for determination of the 1- and 2-butanol concentration. For this, 1 ml of the liquid phase was sampled using a sterile disposable syringe and centrifuged off for 2 minutes in a bench centrifuge. The supernatant was then analyzed by GC for the contents of 1- and 2-butanol. In all of the conversions using 4-methylpyrazole (20 mM), a decrease in n-butane was observed. In all reaction solutions the formation of 1-butanol was observed, but in contrast only a very low formation of 2-butanol was observed. See Table IV below:

TABLE IV

| | | Activity in | Selectivity |
|---|---|---|---|
| | | nmol/min/ | 1-butanol |
| | Strain | mgₚᵣₒₜₑᵢₙ | in % |
| Not according to the | Mycobacterium sp. 11435 | 3.1 | 79.2 |
| invention | | | |
| According to the | Rhodococcus ruber KB1 | 7.2 | 94.8 |
| invention | | | |
| According to the | Arthrobacter sp. 11075 | 2.1 | 97.2 |
| invention | | | |
| According to the | Rhodococcus ruber DSM | 3.8 | 95.8 |
| invention | 7511 | | |
| According to the | Rhodococcus ruber SW3 | 1.4 | 94.9 |
| invention | | | |

1.6.4. Conversion of n-hexane using microorganisms and 4-methylpyrazole as inhibitor

In accordance with the above-described culture method, cells of bacterial strains breaking down n-hexane were cultured in a mineral medium containing 0.1% n-hexane. At the end of the exponential growth phase, the cells were harvested by centrifugation and resuspended in phosphate buffer to give an optical density of 2-5. Each cell suspension was transferred to 300 ml conical flasks equipped with baffles. After determination of the optical density and addition of 0. 1% n-hexane and 20 mM 4-methylpyrazole as inhibitor, the solution was sealed air-tightly and each cell suspension was incubated at 30° C. in a shaking water bath at 100 rpm. At intervals of initially half an hour, later one hour or longer, gas samples were taken using an air-tight syringe and analyzed by GC. In addition, samples were taken for determination of the 1-, 2- and 3-hexanol concentrations. For this, 1 ml of the liquid phase was sampled using a sterile disposable syringe and centrifuged for 2 minutes in a bench centrifuge. The supernatant was then analyzed by GC for the contents of 1-, 2- and 3- hexanol. In all of the conversions, a decrease in n-hexane was observed. In particular, the formation of 1-hexanol was observed, but virtually no formation of 2-hexanol was observed in the solutions. See Table V below:

TABLE V

| | | Activity in | Selectivity |
|---|---|---|---|
| | | nmol/min/ | 1-hexanol |
| | Strain | mgₚᵣₒₜₑᵢₙ | in % |
| Not according to | Mycobacterium | 2.0 | 78.5 |
| the invention | sp. 11435 | | |
| According to | Rhodococcus ruber KB1 | 4.3 | 92.0 |
| the invention | | | |
| According to | Arthrobacter sp. 11075 | 2.7 | 90.0 |
| the invention | | | |

2. Tolerance tests (studies on the tolerance of microorganisms towards 1-butanol)

2.1 Enrichment and isolation of 1 -butanol-tolerant bacterial strains

The newly isolated 1-butanol-tolerant bacterial strains were enriched and isolated as follows. Complex medium (20 ml) of the following composition: 10 g of tryptone, 5 g of yeast extract, 10 g of NaCl, 1 g of MgSO₄·7H₂O, 0.1 g of CaC1₂·H₂O in 1,000 ml of H₂O was admixed with approximately 5 g of soil or 1-2 ml of activated sludge from a sewage treatment plant and incubated in the presence of 1-2% 1-butanol at 30° C. in air-tightly sealed 100 ml conical flasks equipped with baffles. The enrichment cultures were transferred repeatedly to fresh nutrient medium. In the event of good growth (determined by measuring the optical density at 546 nm), one aliquot was plated out in each case on solid complex medium. The bacterial strains which were enriched in this way were isolated individually and the growth was tested using these in a complex medium in the presence of 1-2% 1-butanol. Pure cultures were thus obtained which could grow in a complex medium in the presence of 1-butanol.

2.2 Identification of the bacterial strains

Two newly isolated bacterial strains, Bacillus subtilis US-K2 and Corynebacterium sp. US-K1, were classified by means of partial 16S rDNA sequencing. Sequencing was performed using Sander's dideoxy chain method. In addition, two further bacterial strains, Bacillus sp. US-K4 and Corynebacterium sp. US-K5, were identified by the DSMZ (Deutsche Sammlung für Mikroorganismen and Zellkulturen).

2.3 Long-term culture

The butanol-tolerant bacterial strains were maintained on solid complex medium plates at 4° C. which had been previously incubated at 30° C. for 1-2 days. The bacterial strains were transferred every 2 weeks to fresh nutrient media. For solid nutrient media, 15 g of agar/1 were added to the above-described medium. In addition, all bacterial strains were stored at −70° C. For this, 0.5 ml of a culture which had grown in butanol-containing complex medium (1%) was mixed with 0.5 ml of glycerol and shock-frozen in liquid nitrogen in a cryotube.

2.4. Growth experiments in butanol-containing complex medium

The above-described complex medium was used for the growth of bacterial strains in liquid cultures in the presence of 1-butanol. For the growth experiments, in each case 20 ml of complex medium in air-tightly sealed conical flasks equipped with baffles were inoculated with a preculture which had grown in complex medium or butanol-containing complex medium. Each cell suspension was incubated at 30° C on a rotary shaker at 120 rpm. Cell growth was determined by measuring optical density at 546 nm. In addition, the viable cell count was also determined. If an increase in optical density or in viable cell count was observed in the presence of a set percentage of 1-butanol, the strain was termed 1-butanol tolerant. For the individual strains tested, the following tolerance limits to 1-butanol were determined, see Table VI below:

TABLE VI

| | | Tolerance |
|---|---|---|
| | | limits in % |
| | Strain | 1-butanol |
| Not according to the invention | Escherichia coli | 0.5 |
| Not according to the invention | Mycobacterium sp. 11435 | 0.9 |
| According to the invention | Bacillus sp. US-K2 | 2.0 |
| According to the invention | Corynebacterium | 2.3 |
| | sp. US-K1 | |
| According to the invention | Rhodococcus ruber | 1.4 |
| | DSM 7511 | |
| According to the invention | Corynebacterium | 2.6 |
| | sp. US-K5 | |
| According to the invention | Arthrobacter sp. 11075 | 1.4 |
| According to the invention | Rhodococcus ruber KB1 | 1.4 |

Modifications and other embodiments

Various modifications and variations of the described microorganisms, processes and methods, as well as the concept of the invention will be apparent to those skilled in the art without departing from the scope and spirit of the invention. Although the invention has been described in connection with specific preferred embodiments, it should be understood that the invention as claimed is not intended to be limited to such specific embodiments. Various modifications of the described modes for carrying out the invention which are obvious to those skilled in the chemical, biological, molecular biological arts or in related fields are intended to be within the scope of the following claims.

Incorporation by Reference

Each document, patent application or patent publication cited by or referred to in this disclosure is incorporated by reference in its entirety. Any patent document to which this application claims priority is also incorporated by reference in its entirety. Specifically, German priority documents 100 20 706.5, filed Apr. 27, 2000 and 100 33 098.3, filed Jul. 07, 2000 are hereby incorporated by reference.

1. A process for the oxidation of a hydrocarbon having 2 to 20 carbon atoms comprising:
oxidizing a hydrocarbon having 2 to 20 carbon atoms using a microorganism expressing an alkane hydroxylase, which is tolerant towards the primary oxidation product of said hydrocarbon, or
using an extract of said microorganism having alkane hydroxylase activity.

2. The process of claim 1, wherein said microorganism is a bacterium.

3. The process of claim 1, wherein said microorganism is a bacterium selected from the group consisting of Rhodococcus ruber KB 1, Rhodococcus ruber DSM 7511, Rhodococcus ruber SW 3, Arthrobacter sp. 11075, and mutants or variants thereof.

4. The process of claim 2, wherein a gene of said bacterium required for hydrocarbon oxidation is expressed heterologously in another, recombinant bacterial strain.

5. The process of claim 4, wherein the recombinant bacterium is selected from the group consisting of Escherichia coli, Corynebacterium, Bacillus and Bacillus subtilis.

6. The process of claim 5, wherein said recombinant bacterium is selected from the group consisting of Escherichia coli, Corynebacterium sp. US-K1, Corynebacterium sp. USK5, Bacillus sp. US-K4 and Bacillus subtilis US-K2.

7. The process of claim 1, wherein a cell-free extract of said microorganism is used for the hydrocarbon oxidation.

8. The process of claim 7, wherein said cell-free extract comprises an alkane hydroxylase.

9. The process of claim 8, wherein said hydroxylase is immobilized on a stationary phase.

10. The process of claim 1, wherein an alcohol corresponding to the oxidized hydrocarbon is obtained.

11. The process of claim 10, wherein the corresponding alcohol is obtained in the presence of an inhibitor of further oxidation of said alcohol.

12. The process of claim 1, wherein the hydrocarbon is terminally oxidized.

13. The process of claim 1, wherein the hydrocarbon is terminally oxidized with a selectivity of at least about 80%.

14. The process of claim 1, wherein a hydrocarbon having 2 to 7 carbon atoms is used.

15. The process of claim 1, wherein, said hydrocarbon is present in a mixture of hydrocarbons.

16. The process of claim 1, wherein from a hydrocarbon mixture, essentially only unbranched hydrocarbons are oxidized.

17. Process of claim 1, wherein an aliphatic substituent of an aromatic hydrocarbon is oxidized.

18. The process of claim 1, wherein the further oxidation or reaction of the primary oxidation product is impeded or suppressed.

19. The process of claim 18, wherein the further oxidation or reaction of the primary oxidation product is impeded or suppressed by selective deactivation or removal of one or more alkanol dehydrogenase genes from said microorganism.

20. A method for isolating or identifying a bacterium comprising a gene for the oxidation of hydrocarbons having 2 to 20 carbon atoms comprising:
growing a bacterium or a mixture of bacteria in a suitable medium comprising an hydrocarbon having 2 to 20 carbon atoms as the sole carbon or energy source,
and selecting a bacterium capable of growth on said hydrocarbon.

21. An isolated bacterium comprising a gene for oxidation of hydrocarbons having 2 to 20 carbon atoms obtainable by a method comprising:
growing said bacterium or a mixture of bacteria comprising said bacterium in a suitable medium comprising a hydrocarbon having 2 to 20 carbon atoms as the sole carbon or energy source,
and isolating said bacterium capable of growth on said hydrocarbon having 2 to 20 carbon atoms.

22. An isolated bacterium selected from the group consisting of Rhodococcus ruber KB1, Rhodococcus ruber DSM 7511, Rhodococcus ruber SW 3, Arthrobacter sp. 11075, and mutants or variants thereof.

23. A recombinant bacterium, comprising a gene for oxidation of hydrocarbons having from 2 to 20 carbon atoms, wherein said gene is obtained from a bacterium selected from the group consisting of Rhodococcus ruber KB1, Rhodococcus ruber DSM 7511, Rhodococcus ruber SW 3, Arthrobacter sp. 11075, and mutants or variants thereof.

24. A method for removing a hydrocarbon contaminant comprising 2 to 20 carbon atoms from a substrate, comprising:
contacting said substrate with a bacterium selected from the group consisting of Rhodococcus ruber KB1, Rhodococcus ruber DSM 7511, Rhodococcus ruber SW 3, Arthrobacter sp. 11075, and mutants or variants thereof.

25. The method of claim 24, wherein said substrate is soil, sludge or solid waste.

26. The method of claim 24, wherein said substrate is water, or liquid waste or sewage contaminated with hydrocarbons.
